(19) United States
(12) Patent Application Publication
(10) Pub. No.: US 2023/0318037 A1
(43) Pub. Date: Oct. 5, 2023

(54) METHOD FOR PREPARING A LITHIUM ION SECONDARY BATTERY AND A LITHIUM ION SECONDARY BATTERY PREPARED THEREFROM

(71) Applicant: MURATA MANUFACTURING CO., LTD., Kyoto (JP)

(72) Inventors: Hao ZHANG, Shanghai (CN); Geng ZHANG, Shanghai (CN); Cheng ZHU, Shanghai (CN)

(21) Appl. No.: 18/127,073

(22) Filed: Mar. 28, 2023

(30) Foreign Application Priority Data
Mar. 31, 2022 (CN) 2022103350976

(51) Int. Cl. H01M 10/0567; H01M 10/0568; H01M 10/0569; H01M 10/0525; H01M 50/609

(52) U.S. Cl. CPC H01M 10/0567; H01M 10/0568; H01M 10/0569; H01M 10/0525; H01M 50/609; H01M 2300/0028

(57) ABSTRACT

The present invention provides a method for preparing a lithium ion secondary battery and a lithium ion secondary battery prepared therefrom. The method for preparing a lithium ion secondary battery comprises the following steps: step S1, injecting a first electrolyte containing a fluorobenzene-based additive, an organic solvent and a lithium salt into a battery assembly, wherein the battery assembly comprises a positive electrode, a negative electrode and a separator; step S2, subjecting the battery assembly to pre-formation; and step S3, injecting a second electrolyte containing chain fluoroester into the battery assembly. The method for preparing the lithium ion secondary battery and the lithium ion secondary battery prepared therefrom can achieve better protection of electrodes, and excellent cycling performance at high temperatures as well as low post cycle impedance.

### TECHNICAL FIELD

The present invention relates to the field of lithium ion secondary batteries, in particular to a method for preparing a lithium ion secondary battery and a lithium ion secondary battery prepared therefrom.

### BACKGROUND

In recent years, along with the continuous updating of electronic technology, the requirements for people to a battery device for supporting the energy supply of electronic device are also increased. Nowadays, batteries capable of storing a high amount of electricity and outputting high power are needed. Traditional lead-acid batteries and nickel hydrogen batteries and the like may not meet the requirements of new electronic products, for example mobile devices such as smart phones and fixed devices such as power storage systems and the like. Therefore, lithium battery has attracted more and more attentions of the people. During the development process of lithium battery, its capacity and performance have been effectively improved. Lithium ion batteries have the advantages of high energy density, high working voltage, long cycle life, and low environmental pollution and the like. They have become novel green high-energy chemical power supply with great development potential in the world today. Electrolyte is an important component of lithium ion battery, which has an important impact on many performances of batteries, such as voltage, energy density, power, lifespan, applicable temperature range and safety and the like.

In the developing process of the electrolyte of lithium ion secondary battery, it was found that adding electrolyte additives would help to protect the electrodes of a battery from corrosion by electrolyte solvent. In the process of battery pro-formation (initial charge and discharge cycle), the electrolyte additive will precede the electrolyte solvent to decompose and form a film on the surface of the positive electrode or negative electrode, thereby protecting the electrodes. The action mechanisms of additives and solvents in the battery are different. When the additives forming a film at the positive electrode, higher HOMO energy is needed for the additives to lose electrons easily at positive electrode and to be oxidized to form a CEI film (positive electrode electrolyte interfacial film), and when additives forming a film at the negative electrode, lower HOMO energy is needed for the additives to gain electrons easily at negative electrode and to be reduced to form a SEI film (solid electrolyte interfacial film). While, the solvent needs to have certain electrochemical stability, and will not be oxidized or reduced during the charging and discharging process of a battery to cause failure. In the prior art, electrolyte additives, lithium salts and solvents are usually used to prepare electrolyte, and the electrolyte is added to the battery assembly to prepare batteries. Using the above method, a solid electrolyte film could be formed on the surface of the electrode via decomposition of additives and film formation during the first cycle. However, the method for preparing a lithium ion secondary battery used in the prior art cannot effectively protect the electrode, which makes the battery show poor oxidation resistance and high temperature resistance. Therefore, in order to solve the problems mentioned above, it is still necessary to develop a method for preparing a lithium ion secondary battery that can effectively form a SEI film and ensure the electrical performance of a lithium ion secondary battery.

### SUMMARY

The main objective of the present invention is to provide a method for preparing a lithium ion secondary battery and a lithium ion secondary battery prepared therefrom, so as to solve the problem that the method for preparing a lithium ion secondary battery in the prior art cannot effectively protect the electrode, which makes the battery show poor oxidation resistance and high temperature resistance.

In order to achieve the above objective, according to one aspect of the present invention, a method for preparing a lithium ion secondary battery is provided, comprising the following steps: step S1, injecting a first electrolyte containing a fluorobenzene-based additive, an organic solvent and a lithium salt into a battery assembly, wherein the battery assembly comprises a positive electrode, a negative electrode and a separator; step S2, subjecting the battery assembly to pre-formation; and step S3, injecting a second electrolyte containing chain fluoroester into the battery assembly.

Further, in the above method, the fluorobenzene-based additive includes a substance as shown in Formula 1 below:

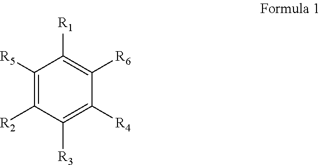

wherein, R₁ is independently selected from substituted or unsubstituted methyl, ethyl, propyl or ethynyl; R₂, R₃ and R₄ are independently selected from H, F, substituted or unsubstituted methyl, ethyl or propyl; and R₅ and R₆ are independently selected from substituted or unsubstituted methyl, H or F, provided that at least one of R₁ to R₆ groups comprises F.

Further, in the above method, R₁ is independently selected from perfluorinated methyl, perfluorinated ethyl, perfluorinated propyl or ethynyl; R₂, R₃ and R₄ are independently selected from H, F, perfluorinated methyl, perfluorinated ethyl or perfluorinated propyl; and R₅ and R₆ are independently selected from H, or F.

Further, in the above method, the fluorobenzene-based additive comprises one of the following substances or any combination thereof:

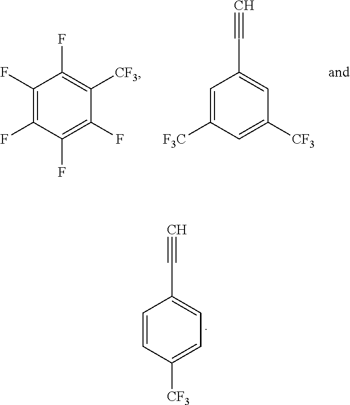 [SMILES: Fc1c(F)c(F)c(C(F)(F)F)c(F)c1F ; C#Cc1cc(C(F)(F)F)cc(C(F)(F)F)c1 ; C#Cc1ccc(C(F)(F)F)cc1]

Further, in the above method, the chain fluoroester comprises one of the following substances or any combination thereof: fluoroethyl acetate, methyl fluoroethyl carbonate or difluoroethyl carbonate.

Further, in the above method, the chain fluoroester comprises one of monofluoroethyl acetate, 2,2-difluoroethyl acetate, 2,2,2-trifluoroethyl acetate, 2,2,2-trifluoroethyl trifluoroacetate, methyl trifluoroethyl carbonate, di(trifluoroethyl)carbonate, di(difluoroethyl)carbonate or ethyl trifluoroethyl carbonate, or any combination thereof.

Further, in the above method, the organic solvent comprises ethylene carbonate, dimethyl carbonate or a combination thereof.

Further, in the above method, based on the total weight of 100 parts by weight of the organic solvent and the lithium salt, the amount of the fluorobenzene-based additive ranges from about 0.5 parts by weight to about 3.0 parts by weight; preferably, based on the total weight of 100 parts by weight of the organic solvent and the lithium salt, the amount of the fluorobenzene-based additive ranges from about 0.5 parts by weight to about 2.0 parts by weight.

Further, in the above method, based on the total weight of 100 parts by weight of the organic solvent and the lithium salt, the amount of the second electrolyte ranges from about 5 parts by weight to about 15 parts by weight; preferably, based on the total weight of 100 parts by weight of the organic solvent and the lithium salt, the amount of the second electrolyte ranges from about 5 parts by weight to about 13 parts by weight.

According to another aspect of the present invention, a lithium ion secondary battery prepared by the above method is provided.

The method for preparing the lithium ion secondary battery and the lithium ion secondary battery prepared therefrom can achieve better protection of electrodes, and excellent cycling performance at high temperatures as well as low post cycle impedance.

### DETAILED DESCRIPTION OF THE EMBODIMENTS

It should be noted that the embodiments and features in the embodiments in the present application can be combined with each other without conflict. The present invention will be described in detail below in combination with embodiments. The following embodiments are only illustrative and do not constitute a limitation on the scope of protection of the present invention.

As described in the background technology, the method for preparing the lithium ion secondary battery in the prior art cannot effectively form the SEI film and cannot guarantee the electrical performance of the lithium ion secondary battery. In view of the problems appeared in the prior art, according to a typical embodiment of the present invention, a method for preparing a lithium ion secondary battery is provided, which comprises the following steps: step S1, injecting a first electrolyte containing a fluorobenzene-based additive, an organic solvent and a lithium salt into a battery assembly, wherein the battery assembly comprises a positive electrode, a negative electrode and a separator; step S2, subjecting the battery assembly to pre-formation; and step S3, injecting a second electrolyte containing chain fluoroester into the battery assembly.

In the prior art, in the process of preparing a lithium ion secondary battery, the electrolyte additive is usually decomposed during the first cycle of the battery and a dense solid electrolyte film is formed on the surface of the electrode. As described previously, higher HOMO energy is needed for the additives to lose electrons easily at positive electrode and to be oxidized to form a CEI film when forming a film at the positive electrode, and lower HOMO energy is needed for the additives to gain electrons easily at negative electrode and to be reduced to form a SEI film when forming a film at the negative electrode. While, the solvent needs to have certain electrochemical stability, and will not be oxidized or reduced during the charging and discharging process of a battery to cause failure. However, since the solvent commonly used in the prior art has low stability, it may be oxidized or decomposed.

The inventor of the present invention has carried out a large number of experiments and surprisingly found that the fluorobenzene-based additive has the advantages of low melting point, high flash point, and high oxygenolysis voltage and the like, due to the strong electronegativity and weak polarity of fluorine. During the reaction processes of substances, the molecular orbitals interact each other, the frontier orbitals preferentially function, and the frontier orbitals reflect the physical and chemical properties of substances to a large extent. The higher the highest occupied molecular orbital (HOMO) energy, the more unstable the electrons in the orbitals, and the more likely they are to be lost and oxidized. On the contrary, the lower the lowest unoccupied molecular orbital (LUMO) energy, the easier it is to obtain electrons and be reduced. In the embodiments of the present invention, the fluorobenzene-based additives are added to the electrolyte during the first liquid injection. Since the additive has a lower LUMO energy level after the substitution of fluorine, it can decompose on the surface of the negative electrode prior to the electrolyte solvent to form a stable SEI film to protect the electrode material and prevent the electrolyte from directly contacting the electrodes. The fluorobenzene-based additive introduced during the first liquid injection has an aromatic structure. Compared with the chain film forming additive commonly used in the prior art, the fluorobenzene-based additive of the present invention can form a dense SEI film on the surface of electrode, which can better isolate the electrolyte from the active substances, and inhibit the occurrence of side reactions.

After the pre-formation, the method of the present invention further comprises injecting a second electrolyte containing a chain fluoroester or injecting the chain fluoroester as a second electrolyte into the battery assembly. Compared with the solvent used in step S1, the fluorinated solvent has better wettability with the electrode material. Therefore, in the present invention, the fluorinated solvent is further added to the electrolyte of the battery after pre-formation, thereby improving the oxidation resistance and high temperature performance of the electrolyte. In addition, since the surface of the negative electrode has been uniformly covered with a SEI film during the pre-formation, the fluorinated solvent introduced in step S3 will not decompose on the surface of the negative electrode.

In addition, the inventor unexpectedly found that the lithium ion secondary battery prepared by the secondary liquid injection method of the present application has excellent cycling performance at high temperatures and low post cycle impedance.

In some embodiments, the fluorobenzene-based additive used in the method of the present application includes a substance as shown in Formula 1 below:

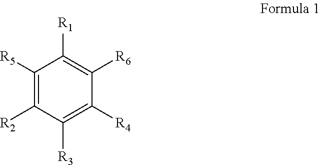

wherein, R₁ is independently selected from substituted or unsubstituted methyl, ethyl, propyl or ethynyl; R₂, R₃ and R₄ are independently selected from H, F, substituted or unsubstituted methyl, ethyl or propyl; and R₅ and R₆ are independently selected from substituted or unsubstituted methyl, H or F, provided that at least one of R₁ to R₆ groups comprises F. Since in the process of forming SEI film, the fluorine substitution is required to make the additive have lower LUMO capacity, the fluorobenzene-based additive used in the present invention comprises at least one F atom as substitution.

In the preferred embodiments of the present invention, in the fluorobenzene-based additives as shown in Formula 1 described above, R₁ is independently selected from perfluorinated methyl, perfluorinated ethyl, perfluorinated propyl or ethynyl; R₂, R₃ and R₄ are independently selected from H, F, perfluorinated methyl, perfluorinated ethyl or perfluorinated propyl; and R₅ and R₆ are independently selected from H, or F. In the preferred embodiments, as many fluorine substitution groups as possible are used in the additives, so that the additives have as low LUMO capacity as possible.

In some embodiments of the present invention, the fluorobenzene-based additive comprises one of the following substances or any combination thereof:

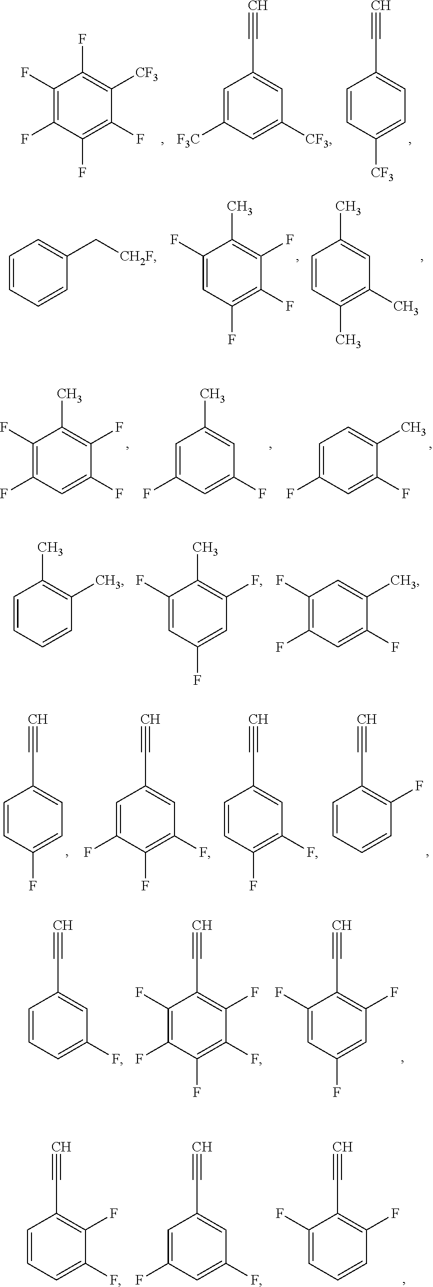

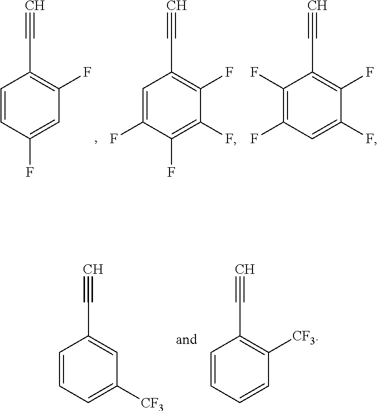

In further embodiments, the fluorobenzene-based additive used in the present invention comprises one of the following substances or any combination thereof:

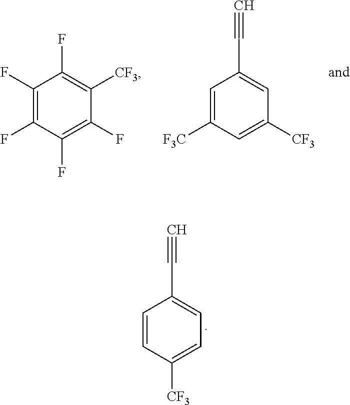 [SMILES: Fc1c(F)c(F)c(C(F)(F)F)c(F)c1F ; C#Cc1cc(C(F)(F)F)cc(C(F)(F)F)c1 ; C#Cc1ccc(C(F)(F)F)cc1]

In some embodiments of the present invention, the chain fluoroester used in step S3 of the present invention comprises one of the following substances or any combination thereof: fluoroethyl acetate, methyl fluoroethyl carbonate or difluoroethyl carbonate. Since the fluorinated solvent can improve the oxidation resistance and high temperature performance of the electrolyte, fluoroethyl acetate, methyl fluoroethyl carbonate or difluoroethyl carbonate are introduced in the electrolyte during the second liquid injection process of the present application.

In further embodiments, the chain fluoroester used in the present invention comprises one of monofluoroethyl acetate, 2,2-difluoroethyl acetate, 2,2,2-trifluoroethyl acetate, 2,2,2-trifluoroethyl trifluoroacetate, methyl trifluoroethyl carbonate, di(trifluoroethyl)carbonate, di(difluoroethyl)carbonate or ethyl trifluoroethyl carbonate, or any combination thereof. In particularly preferred embodiments, the chain fluoroester used in the present invention includes one of difluoroethyl acetate, methyl trifluoroethyl carbonate or di(trifluoroethyl) carbonate or any combination thereof.

In the present invention, the organic solvent used in the first liquid injection (step S1) can be any non-aqueous solvent used so far for non-aqueous electrolyte solutions. Examples of organic solvents that can be used in the present application include but are not limited to straight chain or cyclic carbonates such as ethylene carbonate, propylene carbonate, butylene carbonate, diethyl carbonate, dimethyl carbonate, methyl ethyl carbonate, dipropyl carbonate; ethers such as 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, diethyl ether; sulfones, such as sulfolane, and methyl sulfolane; nitriles, such as acetonitrile, propionitrile, acrylonitrile; and esters, such as acetate, propionate, and butyrate and the like. These non-aqueous solvents can be used alone or in combination. In some embodiments of the present invention, the preferred organic solvents include ethylene carbonate, propylene carbonate, butylene carbonate, diethyl carbonate, dipropyl carbonate, methyl ethyl carbonate, vinyl carbonate and/or dimethyl carbonate, as well as any combination thereof. In further preferred embodiments, the organic solvent comprises ethylene carbonate, dimethyl carbonate or a combination thereof. In a preferred embodiment, at least one carbonate is used as the organic solvent in the electrolyte of the present invention. In another preferred embodiments, the non-aqueous solvent described above can be used in any combination to form an electrolyte solution meeting specific requirements.

In some embodiments of the present invention, in the first liquid injection, based on the total weight of 100 parts by weight of the organic solvent and the lithium salt, the amount of the fluorobenzene-based additive ranges from about 0.5 parts by weight to about 3 parts by weight; preferably, based on the total weight of 100 parts by weight of the organic solvent and the lithium salt, the amount of the fluorobenzene-based additive ranges from about 0.5 parts by weight to about 2 parts by weight. Within the above range of addition amount, fluorobenzene-based additives will form a dense solid electrolyte film on the surface of the negative electrode under the action of pre-formation, so as to protect the electrode from corrosion, and prevent the chain fluoroester added in the secondary liquid injection from decomposing on the surface of the negative electrode. When the amount of the fluorobenzene-based additive is less than about 0.5 parts by weight, it is impossible to form a good and dense electrolyte film at both the positive and negative electrodes. When the amount of the fluorobenzene-based additive is more than about 3 parts by weight, the formed electrolyte film is too thick, which will adversely affect the cycle efficiency of the lithium ion secondary battery and adversely increase the battery impedance.

In different embodiments of the present invention, according to different choices of organic solvents and lithium salts, and different performance requirements of lithium ion secondary batteries, the lower limit of the amount of fluorobenzene-based additives should be about 0.5 parts by weight, about 0.6 parts by weight, about 0.7 parts by weight, about 0.8 parts by weight, about 0.9 parts by weight, about 1.0 part by weight, about 1.1 parts by weight, about 1.2 parts by weight, about 1.3 parts by weight, about 1.4 parts by weight, about 1.5 parts by weight, about 1.6 parts by weight, about 1.7 parts by weight, about 1.8 parts by weight, about 1.9 parts by weight or about 2.0 parts by weight, based on the total weight of 100 parts by weight of organic solvents and lithium salts. Moreover, according to different choices of organic solvents and lithium salts, and different performance requirements of lithium ion secondary batteries, the upper limit of the amount of fluorobenzene-based additives should be about 3.0 part by weight, about 2.9 parts by weight, about 2.8 parts by weight, about 2.7 parts by weight, about 2.6 parts by weight, about 2.5 parts by weight, about 2.4 parts by weight, about 2.3 parts by weight, about 2.2 parts by weight, about 2.1 parts by weight or about 2.0 parts by weight, based on the total weight of 100 parts by weight of organic solvents and lithium salts.

Specifically, based on the total weight of 100 parts by weight of organic solvents and lithium salts, the amount of fluorobenzene-based additives can be in the following ranges: a range of about 0.5 parts by weight to about 3.0 parts by weight, a range of about 0.6 parts by weight to about 3.0 parts by weight, a range of about 0.7 parts by weight to about 3.0 parts by weight, a range of about 0.8 parts by weight to about 2.5 parts by weight, a range of about 0.9 parts by weight to about 2.0 parts by weight, a range of about 1.0 part by weight to about 1.5 parts by weight, a range of about 0.5 parts by weight to about 1.0 part by weight, a range of about 0.5 parts by weight to about 1.5 parts by weight, a range of about 0.5 parts by weight to about 2 parts by weight, a range of about 0.5 parts by weight to about 2.5 parts by weight, a range of about 0.5 parts by weight to about 3.0 parts by weight, a range of about 0.6 parts by weight to about 2.0 parts by weight, a range of about 0.7 parts by weight to about 2.0 parts by weight, a range of about 0.8 parts by weight to about 2.0 parts by weight, a range of about 0.9 parts by weight to about 2.0 parts by weight or a range of about 1.0 part by weight to about 2.0 parts by weight.

The present invention has no special restrictions on the lithium salt components contained in the electrolyte, and those known in the prior art that can be used for the electrolyte of a lithium battery can be used. Examples of lithium salts include but are not limited to: LiCl, LiBr, LiPF₆, LiBF₄, LiAsF₆, LiClO₄, LiB(C₆H₅)₄, LiCH₃SO₃, LiCF₃SO₃, LiN(SO₂F)₂, LiN(SO₂CF₃)₂, LiC(SO₂CF₃)₃, LiAlCl₄ and/or Li₂SiF₆, and any combination thereof.

In some embodiments of the present invention, in the second liquid injection, based on the total weight of the organic solvent and the lithium salt, the amount of the second electrolyte ranges from about 5 parts by weight to about 15 parts by weight; preferably, based on the total weight of 100 parts by weight of the organic solvent and the lithium salt, the amount of the second electrolyte ranges from about 5 parts by weight to about 13 parts by weight. In the above weight range, the second electrolyte can effectively infiltrate the electrode materials, and significantly improve the oxidation resistance and high temperature performance of the lithium ion secondary battery.

In different embodiments of the present invention, based on the total weight of 100 parts by weight of the organic solvent and the lithium salt, the lower limit of the second electrolyte should be about 5 parts by weight, about 5.5 parts by weight, about 6 parts by weight, about 6.5 parts by weight, about 7 parts by weight, about 7.5 parts by weight, about 8 parts by weight, about 8.5 parts by weight, about 9 parts by weight, about 9.5 parts by weight or about 10 parts by weight. Moreover, based on the total weight of 100 parts by weight of the first electrolyte and the second electrolyte, the upper limit of the second electrolyte should be about 15 parts by weight, about 14.5 parts by weight, about 14 parts by weight, about 13.5 parts by weight, about 13 parts by weight, about 12.5 parts by weight, about 12 parts by weight, about 11.5 parts by weight, about 11 parts by weight, about 10.5 parts by weight or about 10 parts by weight.

Specifically, based on the total weight of 100 parts by weight of the organic solvent and the lithium salt, the amount of the second electrolyte can be within the following ranges: within a range of about 5 parts by weight to about 15 parts by weight, within a range of about 5.5 parts by weight to about 14.5 parts by weight, within a range of about 6 parts by weight to about 14 parts by weight, within a range of about 6.5 parts by weight to about 13.5 parts by weight, within a range of about 7 parts by weight to about 13 parts by weight, within a range of about 7.5 parts by weight to about 12.5 parts by weight, within a range of about 8 parts by weight to about 12 parts by weight, within a range of about 8.5 parts by weight to about 11.5 parts by weight, within a range of about 9 parts by weight to about 11 parts by weight, within a range of about 9.5 parts by weight to about 10.5 parts by weight, within a range of about 5 parts by weight to about 13 parts by weight, within a range of about 5 parts by weight to about 12 parts by weight, within a range of about 5 parts by weight to about 11 parts by weight, within a range of about 5 parts by weight to about 10 parts by weight, within a range of about 5 parts by weight to about 9 parts by weight, within a range of about 5 parts by weight to about 8 parts by weight, within a range of about 5 parts by weight to about 7 parts by weight, within a range of about 5 parts by weight to about 6 parts by weight, within a range of about 6 parts by weight to about 10 parts by weight, within a range of about 7 parts by weight to about 10 parts by weight, within a range of about 8 parts by weight to about 10 parts by weight or within a range of about 9 parts by weight to about 10 parts by weight.

In another typical embodiment of the present invention, a lithium ion secondary battery prepared by the method for preparing the lithium ion secondary battery according to the present invention is provided. Since the battery is prepared by the method for preparing the lithium ion secondary battery according to the present invention, it has excellent oxidation resistance and high temperature resistance.

The positive electrode sheet of the present invention comprises a positive electrode current collector and a positive electrode active material layer containing positive electrode active material. A positive electrode active material layer is formed on two surfaces of the positive electrode current collector. Metal foils such as aluminum foil, nickel foil and stainless steel foil can be used as positive electrode current collector.

The positive electrode active material layer contains one or two or more of the positive electrode materials that can absorb and release lithium ions as positive electrode active materials, and may contain additional materials, such as positive electrode binder and/or positive electrode conductive agent, if necessary.

Preferably, the positive electrode material is a lithium containing compound. Examples of such lithium containing compounds include a lithium transition metal composite oxide, a lithium transition metal phosphate compound, and the like. A lithium transition metal composite oxide is an oxide containing Li and one or more than two transition metal elements as constituent elements, and a lithium transition metal phosphate compound is a phosphate compound containing Li and one or more than two transition metal elements as constituent elements. Among them, the transition metal elements are advantageously any one or two or more of Co, Ni, Mn, and Fe and the like.

Examples of the lithium transition metal composite oxide include, for example, LiCoO₂, LiNiO₂ and the like. Examples of the lithium transition metal phosphate compound include, for example, LiFePO₄, LiFe₁₋ᵤMnᵤPO₄ (0<u<1), and the like.

In some embodiments of the present application, the positive electrode material can be a ternary positive electrode material, such as lithium nickel-cobalt aluminate (NCA) or lithium nickel-cobalt manganate (NCM). Specific examples can be NCA, LiₓNi_{y}Co_{z}Al_{1-y-z}O₂ (1≤x≤1.2, 0.5≤y≤1, and 0≤z≤0.5); and NCM, LiNiₓCo_{y}Mn_{z}O₂ (x+y+z=1, 0<x<1, 0<y<1, 0<z<1). Specific examples of the positive electrode materials may include, but are not limited to the following materials: LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂ and Li_{1.15}(Mn_{0.65}Ni_{0.22}Co_{0.13})O₂, LiFePO₄, LiMnPO₄, LiFe_{0.5}Mn_{0.5}PO₄ and LiFe_{0.3}Mn_{0.7}PO₄.

In addition, the positive electrode material can be, for example, any one or two or more of an oxide, a disulfide, a chalcogenide, a conductive polymer, lithium cobaltate, lithium manganate, nickel cobalt manganese ternary materials and the like. Examples of the oxide include, for example, titanium oxide, vanadium oxide, and manganese dioxide and the like. Examples of the disulfide include, for example, titanium disulfide, and molybdenum sulfide and the like. Examples of the chalcogenide include, for example, niobium selenide and the like. Examples of the conductive polymer include, for example, sulfur, polyaniline, and polythiophene and the like. However, the positive electrode material may be a material that is different from those described above.

Examples of the positive electrode conductive agent include a carbon material, such as graphite, carbon black, acetylene black and Ketjen black. These can be used alone, or in a combination of two or more of them. It should be noted that the positive electrode conductive agent can be a metal material, a conductive polymer or any analogue, as long as it has conductivity.

Examples of the positive electrode binder include, for example, a synthetic rubber and a polymer material. The synthetic rubber can be, for example, styrene butadiene rubber, fluorine rubber and ethylene propylene diene, and the polymer material can be, for example, polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, lithium polyacrylate, ethylene-propylene-diene terpolymer (EPDM), sulfonated EPDM and polyimide. These can be used alone, or in a combination of two or more of them.

The negative electrode sheet of the present invention comprises a negative electrode current collector and a negative electrode active material layer containing negative electrode active material. A negative electrode active material layer is formed on two surfaces of the negative electrode current collector. Metal foils such as copper (Cu) foil, nickel foil and stainless steel foil can be used as negative electrode current collector.

The negative electrode active material layer contains a material that can absorb and release lithium ions as negative electrode active materials, and may contain additional materials, such as negative electrode binder and/or negative electrode conductive agent, if necessary. The details of the negative electrode binder and the negative electrode conductive agent are the same as those of the positive electrode binder and the positive electrode conductive agent, for example.

The active material of the negative electrode is selected from any one or more of lithium metal, lithium alloy, carbon material, silicon or tin and oxides thereof, or a combination thereof.

Because carbon materials have low potential when absorbing lithium ions, they can obtain high energy density and increase battery capacity. In addition, the carbon material also functions as a conductive agent. Such carbon materials are for example, natural graphite, artificial graphite, materials or analogues obtained by coating them with amorphous carbon. It should be noted that the shape of carbon materials is fibrous, spherical, granular, squamaceous or the like. Silicon based materials include nano silicon, silicon alloy, silicon carbon composite made of SiO_{w} (1<w<2) and graphite. Preferably, SiO_{w} (1<w<2) is SiOₓ (1<x<2), silicon oxide or other silicon based materials.

In addition, the negative electrode material can be, for example, one or more than two of graphitizable carbon, nongraphitizable carbon, a metal oxide, and a polymer compound and the like. Examples of the metal oxide include, for example, iron oxide, ruthenium oxide, and molybdenum oxide and the like. Examples of the polymer compound include, for example, polyacetylene, polyaniline, and polypyrrole and the like. However, the negative electrode material may be another material that is different from those described above.

The separator of the present invention is used to separate the positive electrode sheet from the negative electrode sheet in the battery, enable ions to pass through, and meanwhile prevent the short-circuit current caused by the contact between the two electrode sheets. The separator is, for example, a porous membrane formed of synthetic resin, ceramics or the like, and may be a laminated membrane in which two or more porous membranes are laminated. Examples of the synthetic resin include, for example, polytetrafluoroethylene, polypropylene, polyethylene, and cellulose and the like.

In the embodiments of the present invention, when charging, for example, lithium ions are released from the positive electrode and absorbed in the negative electrode through a non-aqueous electrolyte immersed in the separator. When discharging, for example, lithium ions are released from the negative electrode and absorbed in the positive electrode through a non-aqueous electrolyte immersed in the separator.

The present application will be further described in detail below in combination with specific examples, which cannot be understood as limiting the scope of protection claimed in the present application.

### EXAMPLE 1

Preparation of Negative Electrode

Under vacuum and completely dry conditions and at a temperature of 20° C., 94.0 g of a mixture of SiOₓ (1<x<2) and graphite powder (wherein the amount of SiOₓ (1<x<2) is 9.4 g), 1.9 g of Super-P conductive agent, 3.15 g of CMC binder (sodium carboxymethyl cellulose) and styrene-butadiene rubber (SBR) (wherein the weight ratio of CMC to SBR is 1:1) are weighed and added into water, and stirred evenly, so as to obtain a negative electrode active material slurry. The negative electrode active material slurry is coated on the copper foil to obtain the negative electrode active material layer, which is dried and formed into a negative electrode sheet by the stamping molding process.

Preparation of Positive Electrode

Under vacuum and completely dry conditions and at a temperature of 20° C., 93.0 g of positive electrode active material lithium nickel-cobalt aluminate, 4.0 g of conductive carbon black and 3.0 g of polyvinylidene fluoride are mixed to obtain a positive electrode mixture, and the obtained positive electrode mixture is dispersed in N-methylpyrrolidone to obtain a positive electrode mixture slurry. Then, the positive electrode mixture slurry is coated on an aluminum foil to obtain a positive electrode active material layer, which is dried and formed into a positive electrode sheet by the stamping molding process.

Preparation of Electrolyte

20.0 g of ethylene carbonate, 62.0 g of dimethyl carbonate and 18.0 g of lithium hexafluorophosphate are mixed to prepare the basic electrolyte. 1.0 g of pentafluorotrifluorotoluene is added to the basic electrolyte to obtain the electrolyte of the battery.

Battery Assembly

The CR₂₀₁₆ button battery is assembled in a drying laboratory. The positive electrode sheet obtained in the above steps is used as the positive electrode and the negative electrode sheet is used as the negative electrode. The positive electrode, the negative electrode, the separator and the battery shell of the button battery are assembled and the electrolyte is injected therein. The positive electrode, the negative electrode, the separator and the battery shell of the button battery are assembled. After the battery is assembled, the battery rests for about 24 hours for aging so as to obtain the lithium nickel-cobalt aluminate button battery.

Pre-Formation of Battery

The assembled lithium nickel-cobalt aluminate button battery described above is first rested at 23° C. for 12 hours, and then subjected to one time of charge and discharge cycle at 23° C., with a magnitude of current at 0.1C rate.

Secondary Liquid Injection

After pre-formation, the battery shell of the lithium nickel-cobalt aluminate button battery is opened, then 10.0 g of difluoroethyl acetate as a second electrolyte is added into the battery shell, the battery shell is encapsulated to obtain the lithium nickel-cobalt aluminate button battery of the present application.

### Examples 2-48

The lithium nickel-cobalt aluminate button batteries of Examples 2-48 and Comparative examples 1-7 are prepared according to the same method as Example 1. The differences are shown in the table below:

TABLE 1

| | | Addition | | Addition |
|---|---|---|---|---|
| | Type of | amount of | Type | amount |
| | fluorobenzene-based | fluorobenzene-based | of chain | of chain |
| | additives | additives (g) | fluoroester | fluoroester (g) |
| Example 1 | Pentafluorotrifluorotoluene | 1.0 | Difluoroethyl acetate | 10.0 |
| Example 2 | Pentafluorotrifluorotoluene | 2.0 | Difluoroethyl acetate | 10.0 |
| Example 3 | Pentafluorotrifluorotoluene | 3.0 | Difluoroethyl acetate | 10.0 |
| Example 4 | 3,5-di(trifluoromethyl)phenylacetylene | 1.0 | Difluoroethyl acetate | 10.0 |
| Example 5 | 3,5-di(trifluoromethyl)phenylacetylene | 2.0 | Difluoroethyl acetate | 10.0 |
| Example 6 | 3,5-di(trifluoromethyl)phenylacetylene | 3.0 | Difluoroethyl acetate | 10.0 |
| Example 7 | 4-trifluoromethylphenylacetylene | 1.0 | Difluoroethyl acetate | 10.0 |
| Example 8 | 4-trifluoromethylphenylacetylene | 2.0 | Difluoroethyl acetate | 10.0 |
| Example 9 | 4-trifluoromethylphenylacetylene | 3.0 | Difluoroethyl acetate | 10.0 |
| Example 10 | Pentafluorotrifluorotoluene | 1.0 | Methyl trifluoroethyl | 10.0 |
| | | | carbonate | |
| Example 11 | Pentafluorotrifluorotoluene | 2.0 | Methyl trifluoroethyl | 10.0 |
| | | | carbonate | |
| Example 12 | Pentafluorotrifluorotoluene | 3.0 | Methyl trifluoroethyl | 10.0 |
| | | | carbonate | |
| Example 13 | 3,5-di(trifluoromethyl)phenylacetylene | 1.0 | Methyl trifluoroethyl | 10.0 |
| | | | carbonate | |
| Example 14 | 3,5-di(trifluoromethyl)phenylacetylene | 2.0 | Methyl trifluoroethyl | 10.0 |
| | | | carbonate | |
| Example 15 | 3,5-di(trifluoromethyl)phenylacetylene | 3.0 | Methyl trifluoroethyl | 10.0 |
| | | | carbonate | |
| Example 16 | 4-trifluoromethylphenylacetylene | 1.0 | Methyl trifluoroethyl | 10.0 |
| | | | carbonate | |
| Example 17 | 4-trifluoromethylphenylacetylene | 2.0 | Methyl trifluoroethyl | 10.0 |
| | | | carbonate | |
| Example 18 | 4-trifluoromethylphenylacetylene | 3.0 | Methyl trifluoroethyl | 10.0 |
| | | | carbonate | |
| Example 19 | Pentafluorotrifluorotoluene | 0.5 | Difluoroethyl acetate | 10.0 |
| Example 20 | 3,5-di(trifluoromethyl)phenylacetylene | 0.5 | Difluoroethyl acetate | 10.0 |
| Example 21 | 4-trifluoromethylphenylacetylene | 0.5 | Difluoroethyl acetate | 10.0 |
| Example 22 | Pentafluorotrifluorotoluene | 0.5 | Methyl trifluoroethyl | 10.0 |
| | | | carbonate | |
| Example 23 | 3,5-di(trifluoromethyl)phenylacetylene | 0.5 | Methyl trifluoroethyl | 10.0 |
| | | | carbonate | |
| Example 24 | 4-trifluoromethylphenylacetylene | 0.5 | Methyl trifluoroethyl | 10.0 |
| | | | carbonate | |
| Example 25 | Pentafluorotrifluorotoluene | 1.0 | Difluoroethyl acetate | 5.0 |
| Example 26 | Pentafluorotrifluorotoluene | 1.0 | Difluoroethyl acetate | 13.0 |
| Example 27 | 3,5-di(trifluoromethyl)phenylacetylene | 1.0 | Difluoroethyl acetate | 5.0 |
| Example 28 | 3,5-di(trifluoromethyl)phenylacetylene | 1.0 | Difluoroethyl acetate | 13.0 |
| Example 29 | 4-trifluoromethylphenylacetylene | 1.0 | Difluoroethyl acetate | 5.0 |
| Example 30 | 4-trifluoromethylphenylacetylene | 1.0 | Difluoroethyl acetate | 13.0 |
| Example 31 | Pentafluorotrifluorotoluene | 1.0 | Methyl trifluoroethyl | 5.0 |
| | | | carbonate | |
| Example 32 | Pentafluorotrifluorotoluene | 1.0 | Methyl trifluoroethyl | 13.0 |
| | | | carbonate | |
| Example 33 | Pentafluorotrifluorotoluene | 1.0 | Methyl trifluoroethyl | 15.0 |
| | | | carbonate | |
| Example 34 | 3,5-di(trifluoromethyl)phenylacetylene | 1.0 | Methyl trifluoroethyl | 13.0 |
| | | | carbonate | |
| Example 35 | 4-trifluoromethylphenylacetylene | 1.0 | Methyl trifluoroethyl | 5.0 |
| | | | carbonate | |
| Example 36 | 4-trifluoromethylphenylacetylene | 1.0 | Methyl trifluoroethyl | 13.0 |
| | | | carbonate | |
| Example 37 | Pentafluorotrifluorotoluene | 1.0 | Di(trifluoroethyl)carbonate | 5.0 |
| Example 38 | Pentafluorotrifluorotoluene | 1.0 | Di(trifluoroethyl)carbonate | 10.0 |
| Example 39 | Pentafluorotrifluorotoluene | 1.0 | Di(trifluoroethyl)carbonate | 13.0 |
| Example 40 | Pentafluorotrifluorotoluene | 1.0 | Di(trifluoroethyl)carbonate | 15.0 |
| Example 41 | 3,5-di(trifluoromethyl)phenylacetylene | 1.0 | Di(trifluoroethyl)carbonate | 5.0 |
| Example 42 | 3,5-di(trifluoromethyl)phenylacetylene | 1.0 | Di(trifluoroethyl)carbonate | 10.0 |
| Example 43 | 3,5-di(trifluoromethyl)phenylacetylene | 1.0 | Di(trifluoroethyl)carbonate | 13.0 |
| Example 44 | 3,5-di(trifluoromethyl)phenylacetylene | 1.0 | Di(trifluoroethyl)carbonate | 15.0 |
| Example 45 | 4-trifluoromethylphenylacetylene | 1.0 | Di(trifluoroethyl)carbonate | 5.0 |
| Example 46 | 4-trifluoromethylphenylacetylene | 1.0 | Di(trifluoroethyl)carbonate | 10.0 |
| Example 47 | 4-trifluoromethylphenylacetylene | 1.0 | Di(trifluoroethyl)carbonate | 13.0 |
| Example 48 | 4-trifluoromethylphenylacetylene | 1.0 | Di(trifluoroethyl)carbonate | 15.0 |
| Comparative | No addition | 0 | No addition | 0 |
| example 1 | | | | |
| Comparative | Pentafluorotrifluorotoluene | 5.0 | Difluoroethyl acetate | 10.0 |
| example 2 | | | | |
| Comparative | 3,5-di(trifluoromethyl)phenylacetylene | 5.0 | Difluoroethyl acetate | 10.0 |
| example 3 | | | | |
| Comparative | 4-trifluoromethylphenylacetylen | 5.0 | Difluoroethyl acetate | 10.0 |
| example 4 | | | | |
| Comparative | Pentafluorotrifluorotoluene | 5.0 | Methyl trifluoroethyl | 10.0 |
| example 5 | | | | |
| Comparative | 3,5-di(trifluoromethyl)phenylacetylene | 5.0 | Methyl trifluoroethyl | 10.0 |
| example 6 | | | carbonate | |
| Comparative | 4-trifluoromethylphenylacetylene | 5.0 | Methyl trifluoroethyl | 10.0 |
| example 7 | | | carbonate | |

Test of Battery Performance

Cycle Retention Rate and Post Cycle Impedance at High Temperatures

At room temperature, the lithium nickel-cobalt aluminate button batteries of Examples 1-48 and Comparative examples 1-7 were subjected to charge and discharge test and impedance test at a voltage between 3.0 V and 4.2 V. The batteries of the above Examples and Comparative examples were first subjected to cycle test at 0.1 C once at 25° C., and then subjected to 100 charge and discharge cycle tests at 1 C at a condition of 60° C., so as to determine the cycle retention rate and impedance of the batteries. The experimental results are shown in Table 2 below.

TABLE 2

| | Cycle retention | Post cycle |
|---|---|---|
| Examples | rate (%) | impedance (Ω) |
| Example 1 | 74.12 | 56.3 |
| Example 2 | 73.08 | 60.5 |
| Example 3 | 72.53 | 64.7 |
| Example 4 | 72.46 | 62.8 |
| Example 5 | 71.94 | 64.7 |
| Example 6 | 70.94 | 66.2 |
| Example 7 | 73.24 | 59.0 |
| Example 8 | 72.35 | 63.1 |
| Example 9 | 71.08 | 65.3 |
| Example 10 | 74.27 | 55.8 |
| Example 11 | 72.04 | 59.2 |
| Example 12 | 72.59 | 62.2 |
| Example 13 | 71.85 | 63.7 |
| Example 14 | 70.61 | 66.1 |
| Example 15 | 71.05 | 67.5 |
| Example 16 | 72.63 | 60.3 |
| Example 17 | 71.05 | 65.7 |
| Example 18 | 71.28 | 67.3 |
| Example 19 | 73.24 | 58.7 |
| Example 20 | 71.53 | 66.1 |
| Example 21 | 72.48 | 62.4 |
| Example 22 | 72.96 | 57.3 |
| Example 23 | 70.25 | 65.2 |
| Example 24 | 71.73 | 63.7 |
| Example 25 | 72.51 | 58.6 |
| Example 26 | 70.65 | 67.9 |
| Example 27 | 70.96 | 63.4 |
| Example 28 | 70.73 | 67.6 |
| Example 29 | 72.42 | 62.8 |
| Example 30 | 70.96 | 64.2 |
| Example 31 | 71.06 | 62.5 |
| Example 32 | 70.92 | 66.6 |
| Example 33 | 70.65 | 68.1 |
| Example 34 | 68.89 | 67.5 |
| Example 35 | 70.64 | 67.5 |
| Example 36 | 69.32 | 67.9 |
| Example 37 | 71.28 | 61.4 |
| Example 38 | 72.53 | 62.6 |
| Example 39 | 70.96 | 64.3 |
| Example 40 | 70.69 | 64.5 |
| Example 41 | 70.74 | 65.4 |
| Example 42 | 71.11 | 65.1 |
| Example 43 | 70.77 | 65.6 |
| Example 44 | 70.63 | 65.8 |
| Example 45 | 71.05 | 62.4 |
| Example 46 | 71.46 | 64.2 |
| Example 47 | 70.98 | 65.4 |
| Example 48 | 70.88 | 65.9 |
| Comparative | 70.56 | 68.1 |
| example 1 | | |
| Comparative | 67.28 | 73.5 |
| example 2 | | |
| Comparative | 66.21 | 75.3 |
| example 3 | | |
| Comparative | 67.84 | 75.9 |
| example 4 | | |
| Comparative | 69.46 | 70.1 |
| example 5 | | |
| Comparative | 68.57 | 73.6 |
| example 6 | | |
| Comparative | 68.17 | 71.2 |
| example 7 | | |

As can be seen from the above description that the above examples of the present invention achieve the following technical effects:

It can be seen from the above Examples 1-48 and Comparative Example 1 that compared with the batteries in Comparative Example 1 obtained without adding any fluorobenzene-based additives and without secondary liquid injection using chain fluoroester, the batteries in Examples 1-48 of the present application show improved cycle retention rate and reduced post cycle impedance.

It can be seen from the comparison between Comparative Examples 2-7 and Examples 1-18 that when the content of fluorobenzene-based additive used exceeds the upper limit (3 wt %), due to the formation of too thick electrolyte film on the surface of negative electrode during the pre-formation, the cycle retention rate will be adversely reduced, and the post cycle impedance will also be adversely increased.

The above are only the preferred examples of the present invention, and are not intended to limit the present invention. For those skilled in the art, various modifications and changes can be made to the present invention. Any modifications, equivalent substitutions, improvements, and the like made within the spirit and principle of the present invention shall be included into the protection scope of the present invention.

1. A method for preparing a lithium ion secondary battery, wherein the method comprises the following steps:
step S1, injecting a first electrolyte containing a fluorobenzene-based additive, an organic solvent and a lithium salt into a battery assembly, wherein the battery assembly comprises a positive electrode, a negative electrode and a separator;
step S2, subjecting the battery assembly to pre-formation; and
step S3, injecting a second electrolyte containing chain fluoroester into the battery assembly.

2. The method according to claim 1, wherein the fluorobenzene-based additive comprises a substance as shown in Formula 1 below: 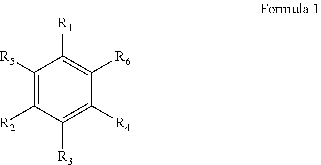
wherein, R₁ is independently selected from substituted or unsubstituted methyl, ethyl, propyl or ethynyl;
R₂, R₃ and R₄ are independently selected from H, F, substituted or unsubstituted methyl, ethyl or propyl; and
R₅ and R₆ are independently selected from substituted or unsubstituted methyl, H or F,
provided that at least one of R₁ to R₆ groups comprises F.

3. The method according to claim 2, wherein R₁ is independently selected from perfluorinated methyl, perfluorinated ethyl, perfluorinated propyl or ethynyl;
R₂, R₃ and R₄ are independently selected from H, F, perfluorinated methyl, perfluorinated ethyl or perfluorinated propyl; and
R₅ and R₆ are independently selected from H, or F.

4. The method according to claim 2, wherein the fluorobenzene-based additive comprises one of the following substances or any combination thereof:

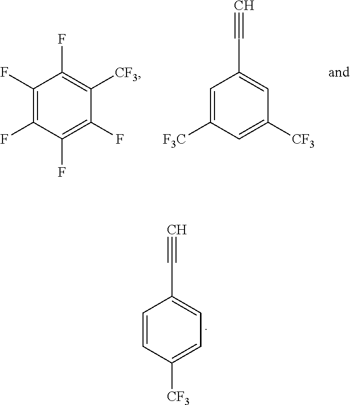 [SMILES: Fc1c(F)c(F)c(C(F)(F)F)c(F)c1F ; C#Cc1cc(C(F)(F)F)cc(C(F)(F)F)c1 ; C#Cc1ccc(C(F)(F)F)cc1]

5. The method according to claim 1, wherein the chain fluoroester comprises one of the following substances or any combination thereof: fluoroethyl acetate, methyl fluoroethyl carbonate or difluoroethyl carbonate.

6. The method according to claim 5, wherein the chain fluoroester comprises one of monofluoroethyl acetate, 2,2-difluoroethyl acetate, 2,2,2-trifluoroethyl acetate, 2,2,2-trifluoroethyl trifluoroacetate, methyl trifluoroethyl carbonate, di(trifluoroethyl)carbonate, di(difluoroethyl)carbonate or ethyl trifluoroethyl carbonate, or any combination thereof.

7. The method according to claim 1, wherein the organic solvent comprises ethylene carbonate, propylene carbonate, butylene carbonate, diethyl carbonate, dimethyl carbonate, methyl ethyl carbonate, dipropyl carbonate, 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, diethyl ether, sulfolane, methyl sulfolane; nitriles, such as acetonitrile, propionitrile, acrylonitrile; esters, such as acetate, propionate, butyrate or a combination thereof; preferably, the organic solvent comprises propylene carbonate, ethylene carbonate, dimethyl carbonate, methyl ethyl carbonate or a combination thereof.

8. The method according to claim 1, wherein based on the total weight of 100 parts by weight of the organic solvent and the lithium salt, the amount of the fluorobenzene-based additive ranges from about 0.5 parts by weight to about 3.0 parts by weight; preferably, based on the total weight of 100 parts by weight of the organic solvent and the lithium salt, the amount of the fluorobenzene-based additive ranges from about 0.5 parts by weight to about 2.0 parts by weight.

9. The method according to claim 1, wherein based on the total weight of 100 parts by weight of the organic solvent and the lithium salt, the amount of the second electrolyte ranges from about 5 parts by weight to about 15 parts by weight; preferably, based on the total weight of 100 parts by weight of the organic solvent and the lithium salt, the amount of the second electrolyte ranges from about 5 parts by weight to about 13 parts by weight.

10. A lithium ion secondary battery prepared by the method of claim 1.
